(19) United States
(12) Patent Application Publication
(10) Pub. No.: US 2024/0330414 A1
(43) Pub. Date: Oct. 3, 2024

(54) CLOUD CONNECTIVITY MANAGEMENT FOR CLOUD-MANAGED ON-PREMISES SOFTWARE

(71) Applicant: VMware, Inc., Palo Alto, CA (US)

(72) Inventors: Stanimir Petkov PEEV, Sofia (BG); Barry GERHARDT, Snohomish, WA (US)

(21) Appl. No.: 18/190,846

(22) Filed: Mar. 27, 2023

(51) Int. Cl. G06F 21/10; G06F 21/62

(52) U.S. Cl. CPC G06F 21/105; G06F 21/629; G06F 21/1013

(57) ABSTRACT

An example method of managing on-premises software executing in a data center includes: probing, by a connectivity agent executing in the data center, connectivity between a cloud service executing in a public cloud and the data center; storing, by the connectivity agent, probe results in a connectivity store of the data center; reading, by connectivity sensing logic in the on-premises software, a current probe result from the connectivity store; and providing, by the on-premises software to a user, functionality based on the current probe result.

### BACKGROUND

In a software-defined data center (SDDC), virtual infrastructure, which includes virtual compute, storage, and networking resources, is provisioned from hardware infrastructure that includes a plurality of host computers, storage devices, and networking devices. The provisioning of the virtual infrastructure is carried out by management software that communicates with virtualization software (e.g., hypervisor) installed in the host computers.

SDDC users move through various business cycles, requiring them to expand and contract SDDC resources to meet business needs. This leads users to employ multi-cloud solutions, such as typical hybrid cloud solutions where the virtualized infrastructure supports SDDCs and “as-a-service” products that span across an on-premises data center and one or more public clouds. In some cases, software executing in the public cloud manages software executing in an on-premises data center (“cloud-managed on-premises software” or “cloud-managed on-prem software”). This management can include lifecycle management operations, such as licensing, updating, and the like.

A traditional model for licensing on-premises software involves a user obtaining a perpetual license from the software provider and applying the perpetual license to the on-premises software to enable feature(s) thereof (e.g., through the use of license key(s)). In a subscription-based licensing model, a user obtains a subscription from the provider and the subscription is applied to the on-premises software, which enables feature(s) thereof for as long as the subscription is maintained. For example, cloud-managed on-premises software can be licensed using the subscription-based model.

Users desire many types of on-premises software to operate within the boundaries of the on-premises data center, such as on internal networks without direct access to the public internet. Cloud-managed on-premises software, however, becomes “cloud bound,” i.e., software for which operation thereof depends on the ability to make a connection to service(s) executing in a public cloud. Thus, the notion of being “cloud bound” can be inconsistent with user requirements for the on-premises software. Hence, there is a need for cloud connectivity management for cloud-managed on-premises software.

### SUMMARY

In an embodiment, a method of managing on-premises software executing in a data center is described. The method includes probing, by a connectivity agent executing in the data center, connectivity between a cloud service executing in a public cloud and the data center. The method includes storing, by the connectivity agent, probe results in a connectivity store of the data center; reading, by connectivity sensing logic in the on-premises software, a current probe result from the connectivity store. The method includes providing, by the on-premises software to a user, functionality based on the current probe result.

Further embodiments include a non-transitory computer-readable storage medium comprising instructions that cause a computer system to carry out the above method, as well as a computer system configured to carry out the above method.

### BRIEF DESCRIPTION OF THE DRAWINGS

FIG. 1 is a block diagram depicting a multi-cloud computing system in which embodiments described herein may be implemented.

FIG. 2 is a block diagram of an SDDC in which embodiments described herein may be implemented.

FIG. 3 is a block diagram depicting cloud connectivity management in a multi-cloud computing system according to embodiments.

FIG. 4 is a flow diagram depicting a method of monitoring cloud connectivity for cloud-managed on-premises software according to embodiments.

FIG. 5 is a block diagram depicting cloud connectivity management in a multi-cloud computing system according to further embodiments.

FIG. 6 is a flow diagram depicting a method of managing temporary access to cloud-managed on-premises software in case of lost cloud connectivity according to embodiments.

### DETAILED DESCRIPTION

In embodiments, the multi-cloud computing system includes a public cloud in communication with one or more data centers through a message fabric. The public cloud includes cloud services executing therein that are configured to manage software executing in the data centers (“cloud-managed on-premises software” or “cloud-managed on-prem software”). For example, an entitlement service executing in the public cloud is configured to interact with virtualization management software executing in a data center for the purpose of applying subscription(s) to the virtualization management software in a subscription-based licensing model. The subscription(s) enable feature(s) of the virtualization management software in the context of managing virtualization software (e.g., hypervisors) installed on hosts of the data center. In embodiments, the cloud services manage the on-premises software using an agent platform appliance executing in the data center. In embodiments, the agent platform appliance and the cloud services communicate through a messaging fabric described further below, as opposed to a virtual private network (VPN) or similar private connection.

The on-premises software, such as the virtualization management software, can be designed to operate within the boundaries of the data center (e.g., on internal networks of the data center) without direct connectivity to the public Internet. In embodiments, the on-premises software managed by the entitlement service in the public cloud is not capable of direct communication with the entitlement service or any other cloud service executing in public cloud. Rather, a cloud service manages the on-premises software through the agent platform appliance executing within the data center. In such a system, the on-premises software cannot directly monitor connectivity with cloud services (e.g., by directly communicating with such cloud services). However, cloud-managed on-premises software is cloud-bound and requires connectivity to the cloud. Techniques are described herein that provide connectivity management for on-premises software, which are described below with respect to the drawings.

One or more embodiments employ a cloud control plane for managing the configuration of SDDCs, which may be of different types and which may be deployed across different geographical regions, according to a desired state of the SDDC defined in a declarative document referred to herein as a desired state document. The cloud control plane is responsible for generating the desired state and specifying configuration operations to be carried out in the SDDCs according to the desired state. Thereafter, configuration agents running locally in the SDDCs establish cloud inbound connections with the cloud control plane to acquire the desired state and the configuration operations to be carried out, and delegate the execution of these configuration operations to services running in a local SDDC control plane.

One or more embodiments provide a cloud platform from which various services, referred to herein as “cloud services” are delivered to the SDDCs through agents of the cloud services that are running in an appliance (referred to herein as an “agent platform appliance”). Cloud services are services provided from a public cloud to on-premises software executing in data centers such as the SDDCs. The agent platform appliance is deployed in the same customer environment, e.g., a private data center, as the management appliances of the SDDCs. In one embodiment, the cloud platform is provisioned in a public cloud and the agent platform appliance is provisioned as a virtual machine in the customer environment, and the two communicate over a public network, such as the Internet. In addition, the agent platform appliance and the on-premises software communicate with each other over a private physical network, e.g., a local area network. Examples of cloud services that are delivered include a configuration service, an upgrade service, a monitoring service, an inventory service, and an entitlement service. Each of these cloud services has a corresponding agent deployed on the agent platform appliance. All communication between the cloud services and the on-premises software of the SDDCs is carried out through the agent platform appliance using a messaging fabric, for example, through respective agents of the cloud services that are deployed on the agent platform appliance. The messaging fabric is software that exchanges messages between the cloud platform and agents in the agent platform appliance over the public network. The components of the messaging fabric are described below.

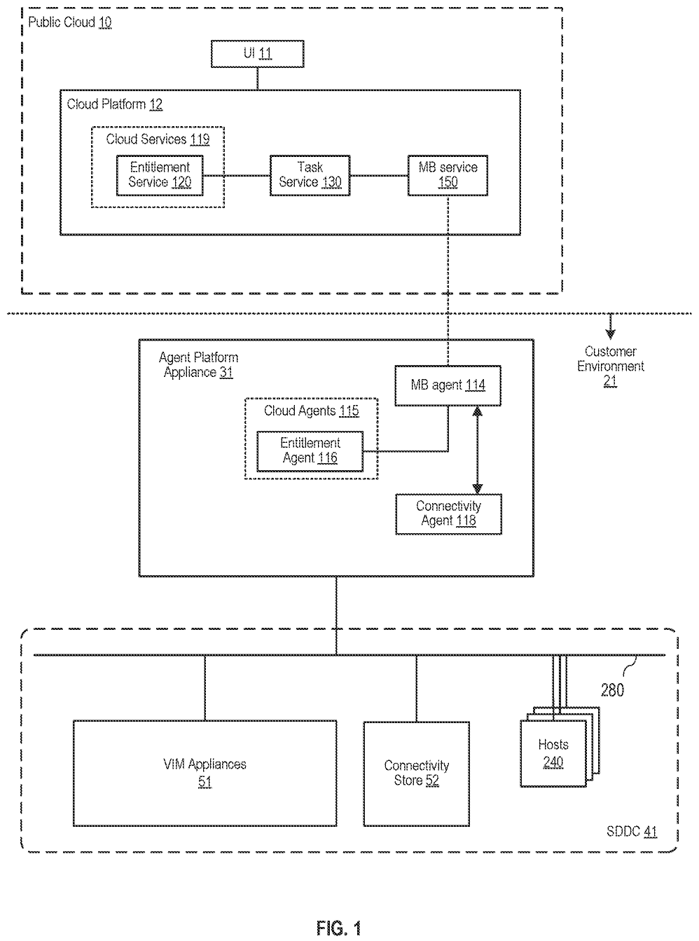

FIG. 1 is a block diagram of customer environments of different organizations (hereinafter also referred to as “customers” or “tenants”) that are managed through a multi-tenant cloud platform 12, which is implemented in a public cloud 10. A user interface (UI) or an application programming interface (API) that interacts with cloud platform 12 is depicted in FIG. 1 1 as UI 11.

An SDDC is depicted in FIG. 1 in a customer environment 21 and is a data center in communication with public cloud 10. In the customer environment, the SDDC is managed by respective virtual infrastructure management (VIM) appliances, e.g., VMware vCenter® server appliance and VMware NSX® server appliance. VIM appliances 51 manage hosts 240 in SDDC 41, which are connected to a physical network 280. The VIM appliances in each customer environment communicate with an agent platform appliance, which hosts agents that communicate with cloud platform 12, e.g., via a messaging fabric over a public network, to deliver cloud services to the corresponding customer environment. For example, the VIM appliances 51 for managing the SDDCs in customer environment 21 communicate with agent platform appliance 31. VIM appliances 51 are an example of on-premises software executing in a data center that is a target of a cloud service executing in public cloud 10. Cloud-managed on-premises software is software executing in the data center with which a cloud service manages as described further herein.

As used herein, a “customer environment” means one or more private data centers managed by the customer, which is commonly referred to as “on-prem,” a private cloud managed by the customer, a public cloud managed for the customer by another organization, or any combination of these. In addition, the SDDCs of any one customer may be deployed in a hybrid manner, e.g., on-premises, in a public cloud, or as a service, and across different geographical regions.

In the embodiments, the agent platform appliance and the management appliances are a VMs instantiated on one or more physical host computers having a conventional hardware platform that includes one or more CPUs, system memory (e.g., static and/or dynamic random access memory), one or more network interface controllers, and a storage interface such as a host bus adapter for connection to a storage area network and/or a local storage device, such as a hard disk drive or a solid state drive. In some embodiments, the agent platform appliance and the management appliances may be implemented as physical host computers having the conventional hardware platform described above.

FIG. 1 illustrates components of cloud platform 12 and agent platform appliance 31. The components of cloud platform 12 include a number of different cloud services 119 that enable each of a plurality of tenants that have registered with cloud platform 12 to manage its SDDCs through cloud platform 12. In embodiments, cloud services 119 include an entitlement service 120 configured to implement a subscription-based licensing model for cloud-managed on-premises software. A user can interact with entitlement service 120 through UI 11 to obtain subscriptions for enabling on-premises software, such as enabling different features of on-premises software. For example, a user can interact with entitlement service 120 to obtain a subscription for a VIM appliance 51. For purposes of clarity by example, other cloud services 119, such as inventory service, configuration service, etc. are omitted.

In one embodiment, each of cloud services 119, task service 130, and message broker (MB) service 150 is a microservice that is implemented as one or more container images executed on a virtual infrastructure of public cloud 10. Similarly, each of cloud agents 115 deployed in agent platform appliance 31 can be a microservice that is implemented as one or more container images executing in the agent platform appliances.

In embodiments, cloud services 119 manage on-premises software in customer environment 21. For example, entitlement service 120 manages subscriptions for on-premises software in SDDC 41, such as VIM appliances 51. Cloud services 119, such as entitlement service 120, make API calls to task service 130 to perform tasks, such as entitlement tasks. Task service 130 then schedules tasks to be performed and creates messages containing the tasks to be performed. Task service 130 inserts the messages in a message queue managed by MB service 150. After scheduling, task service 130 periodically polls MB service 150 for status of the scheduled tasks.

At periodic time intervals, MB agent 114, which is deployed in agent platform appliance 31, makes an API call to MB service 150 to exchange messages that are queued in their respective queues (not shown), i.e., to transmit to MB service 150 messages MB agent 114 has in its queue and to receive from MB service 150 messages MB service 150 has in its queue. MB service 150 implements a messaging fabric on behalf of cloud platform 12 over which messages are exchanged between cloud platform (e.g., cloud services 119) and agent platform appliance 31 (e.g., cloud agents 115). Agent platform appliance 31 can register with cloud platform 12 by executing MB agent 114 in communication with MB service 150. In the embodiment, messages from MB service 150 are routed to respective cloud agents 115. For example, entitlement tasks can be routed to an entitlement agent 116. Entitlement agent 116 issues commands to on-premises software (e.g., VIM appliances 51) targeted in the entitlement tasks (e.g., by invoking APIs of the on-premises software) to perform the entitlement tasks and to check on the status of the entitlement tasks. When an entitlement task is completed by on-premises software, entitlement agent 116 adds a message to the message queue of MB agent 114 to report the completion of the entitlement task.

In embodiments, agent platform appliance 31 includes a connectivity agent 118. Connectivity agent 118 periodically probes access to cloud platform 12. For example, connectivity agent 118 can periodically communicate with MB agent 114 to determine whether MB agent 114 has access to MB service 150 in cloud platform 12. In another example, connectivity agent 118 can communicate with one or more cloud agents 115 (e.g., entitlement agent 116) to determine whether cloud agent(s) 115 are receiving tasks from MB agent 114. In another example, connectivity agent 118 can include a connection with cloud platform 12 external to the messaging framework that allows connectivity agent 118 to probe cloud services 119. Those skilled in the art will appreciate that there are various ways in which connectivity agent 118 can probe access to cloud platform 12 executing in public cloud 10 in addition to those described above.

Connectivity agent 118 stores the result of each probe (e.g., connected versus disconnected with a corresponding timestamp) in a connectivity store 52 maintained in SDDC 41. Embodiments of connectivity store 52 are discussed below. On-premises software executing in SDDC 41 can check connectivity store 52 to determine the connectivity status between SDDC 41 and cloud platform 12. In embodiments, on-premises software can change its functionality in response to learning from connectivity store 52 of a disconnection between SDDC 41 and cloud platform 12. For example, on-premises software managed by entitlement service 120 can deny access to users or otherwise enter a reduced functionality state until the on-premises software learns from connectivity store 52 that the connectivity with cloud platform 12 has been restored. Without connectivity to entitlement service 120, subscription information for on-premises software can become stale or drift from the desired state. In further embodiments described below, the on-premises software can obtain temporary access to reduced functionality (or full functionality) upon learning of a disconnection between SDDC 41 and cloud platform 12.

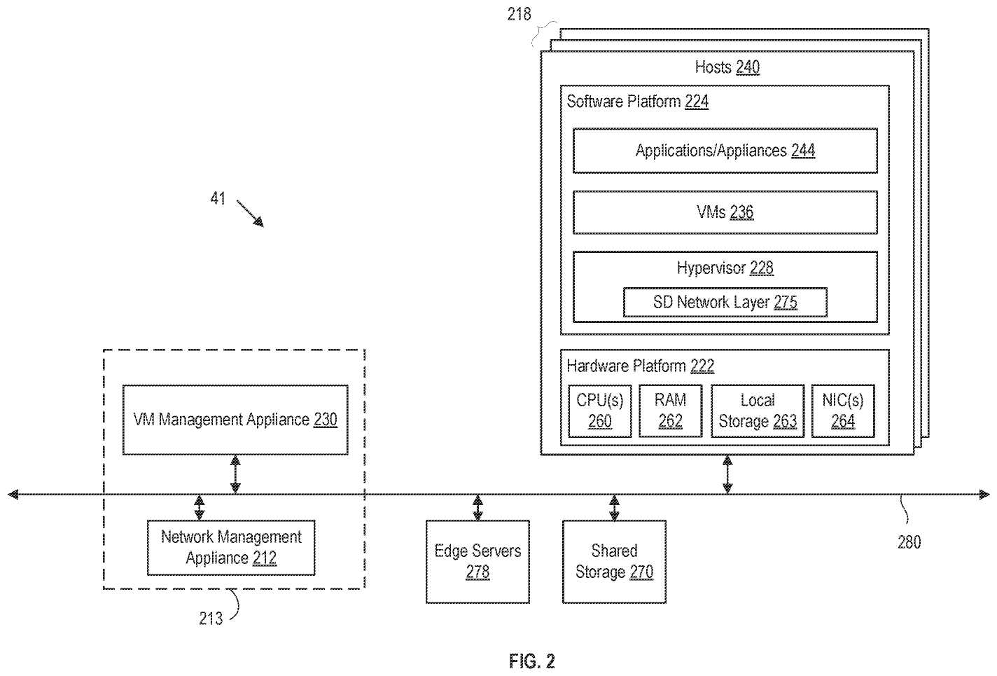

FIG. 2 is a block diagram of SDDC 41 in which embodiments described herein may be implemented. SDDC 41 includes a cluster of hosts 240 (“host cluster 218”) that may be constructed on hardware platforms such as an x86 architecture platforms. For purposes of clarity, only one host cluster 218 is shown. However, SDDC 41 can include many of such host clusters 218. As shown, a hardware platform 222 of each host 240 includes conventional components of a computing device, such as one or more central processing units (CPUs) 260, system memory (e.g., random access memory (RAM) 262), one or more network interface controllers (NICs) 264, and optionally local storage 263. CPUs 260 are configured to execute instructions, for example, executable instructions that perform one or more operations described herein, which may be stored in RAM 262. NICs 264 enable host 240 to communicate with other devices through a physical network 280. Physical network 280 enables communication between hosts 240 and between other components and hosts 240 (other components discussed further herein).

In the embodiment illustrated in FIG. 2, hosts 240 access shared storage 270 by using NICs 264 to connect to network 280. In another embodiment, each host 240 contains a host bus adapter (HBA) through which input/output operations (IOs) are sent to shared storage 270 over a separate network (e.g., a fibre channel (FC) network). Shared storage 270 include one or more storage arrays, such as a storage area network (SAN), network attached storage (NAS), or the like. Shared storage 270 may comprise magnetic disks, solid-state disks, flash memory, and the like as well as combinations thereof. In some embodiments, hosts 240 include local storage 263 (e.g., hard disk drives, solid-state drives, etc.). Local storage 263 in each host 240 can be aggregated and provisioned as part of a virtual SAN, which is another form of shared storage 270.

A software platform 224 of each host 240 provides a virtualization layer, referred to herein as a hypervisor 228, which directly executes on hardware platform 222. In an embodiment, there is no intervening software, such as a host operating system (OS), between hypervisor 228 and hardware platform 222. Thus, hypervisor 228 is a Type-1 hypervisor (also known as a “bare-metal” hypervisor). As a result, the virtualization layer in host cluster 218 (collectively hypervisors 228) is a bare-metal virtualization layer executing directly on host hardware platforms. Hypervisor 228 abstracts processor, memory, storage, and network resources of hardware platform 222 to provide a virtual machine execution space within which multiple virtual machines (VM) 236 may be concurrently instantiated and executed. Applications and/or appliances 244 execute in VMs 236 Applications and/or appliances 244 can include, for example, agent platform appliance 31, as well as cloud-managed on-premises software.

Host cluster 218 is configured with a software-defined (SD) network layer 275 SD network layer 275 includes logical network services executing on virtualized infrastructure in host cluster 218. The virtualized infrastructure that supports the logical network services includes hypervisor-based components, such as resource pools, distributed switches, distributed switch port groups and uplinks, etc., as well as VM-based components, such as router control VMs, load balancer VMs, edge service VMs, etc. Logical network services include logical switches and logical routers, as well as logical firewalls, logical virtual private networks (VPNs), logical load balancers, and the like, implemented on top of the virtualized infrastructure. In embodiments, SDDC 41 includes edge servers 278 that provide an interface of host cluster 218 to a wide area network (WAN) (e.g., a corporate network, the public Internet, etc). Agent platform appliance 31 can access cloud platform 12 through edge servers 278.

VM management appliance 230 (e.g., one of VIM appliances 51 and an example of on-premises software described herein) is a physical or virtual server that manages host cluster 218 and the virtualization layer therein. VM management appliance 230 installs agent(s) in hypervisor 228 to add a host 240 as a managed entity. VM management appliance 230 logically groups hosts 240 into host cluster 218 to provide cluster-level functions to hosts 240, such as VM migration between hosts 240 (e.g., for load balancing), distributed power management, dynamic VM placement according to affinity and anti-affinity rules, and high-availability. The number of hosts 240 in host cluster 218 may be one or many. VM management appliance 230 can manage more than one host cluster 218.

In an embodiment, SDDC 41 further includes a network management appliance 212 (e.g., another VIM appliance 51). Network management appliance 212 is a physical or virtual server that orchestrates SD network layer 275 In an embodiment, network management appliance 212 comprises one or more virtual servers deployed as VMs. Network management appliance 212 installs additional agents in hypervisor 228 to add a host 240 as a managed entity, referred to as a transport node. In this manner, host cluster 218 can be a cluster of transport nodes. One example of an SD networking platform that can be configured and used in embodiments described herein as network management appliance 212 and SD network layer 275 is a VMware NSX® platform made commercially available by VMware, Inc. of Palo Alto, CA. VM management appliance 230 and network management appliance 212 can execute in a management cluster 213, which can include specific ones of hosts 240 or separate hosts (not shown).

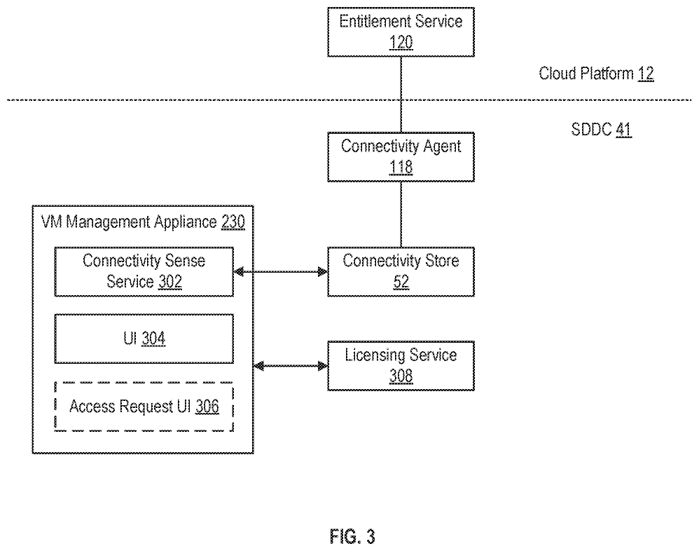

FIG. 3 is a block diagram depicting cloud connectivity management in a multi-cloud computing system according to embodiments. In the embodiment, entitlement service 120 executes in cloud platform 12 on public cloud 10. VM management appliance 230 comprises cloud-managed on-premises software executing in SDDC 41. Entitlement service 120 manages a subscription for VM management appliance 230, which is stored and managed locally by licensing service 308 executing in SDDC 41. Licensing service 308 can execute in a VM 236 and be part of lifecycle management (LCM) software for SDDC 41. Connectivity agent 118 executes in SDDC 41 on a boundary between SDDC 41 and public cloud 10, e.g., within agent platform appliance 31. In embodiments, VM management appliance 230 does not have direct access to cloud platform 12 (i.e., no network connectivity with cloud platform 12) That is, services in VM management appliance 230 cannot connect to cloud services in cloud platform 12 through the network. A user accesses VM management appliance 230 through a UI 304. Connectivity agent 118 probes access with cloud platform 12, such as access to entitlement service 120, using any technique described above.

VM management appliance 230 includes a connectivity sense service 302. Connectivity sense service 302 is configured for communication with connectivity store 52. In embodiments, connectivity store 52 can be a database executing in SDDC 41. In another embodiment, connectivity store 52 can include a file or files stored on storage (e.g., shared storage 270) In another embodiment, connectivity store 52 can include a portion of system memory (e.g., RAM 262) on a host 240. In any embodiment, connectivity store 52 stores probe results generated by connectivity agent 118. A probe result can include an indication of connectivity (connected/disconnected) and a corresponding time stamp. Connectivity sense service 302 obtains connectivity status from connectivity store 52 In this manner, VM management appliance 230 can determine whether SDDC 41 is connected to cloud platform 12. If connectivity with cloud platform 12 is lost, VM management appliance 230 can perform alternative functionality, such as reduced functionality. In embodiments, VM management appliance 230 presents an access request UI 306 to the user upon learning a disconnect between SDDC 41 and cloud platform 12 through connectivity sense service 302. Access request UI 306 is configured to allow the user to generate a temporary access request. Access request UI 306 can be separate from UI 304 to be always available, even when there is no connectivity between SDDC 41 and cloud platform 12. Use of access request UI 306 avoids exposing UI 304 functionality in the case of disconnection. Access request UI 306 can prevent the user from accessing VM management appliance 230 or otherwise present reduced functionality. If connectivity sense service 302 learns there is connectivity between SDDC 41 and cloud platform 12, then VM management appliance 230 performs the licensed functionality. VM management appliance 230 can obtain subscription information from licensing service 308.

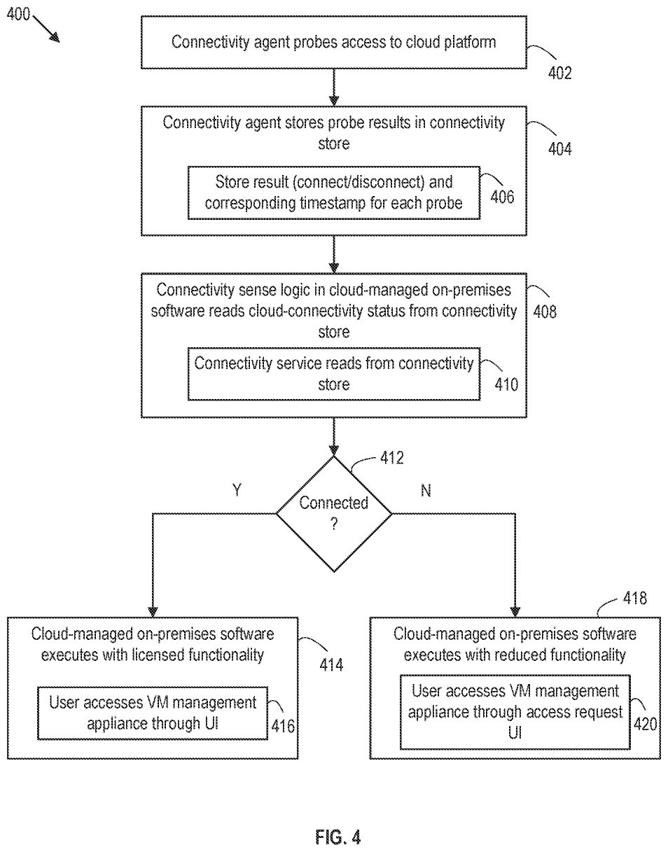

FIG. 4 is a flow diagram depicting a method 400 of monitoring cloud connectivity for cloud-managed on-premises software according to embodiments. Method 400 begins at step 402, where connectivity agent 118 probes access to cloud platform 12. For example, connectivity agent 118 can communicate with MB agent 114 to determine cloud connectivity, with any cloud agent 115 to determine cloud connectivity, or with any cloud service 119 such as entitlement service 120 At step 404, connectivity agent 118 stores probe results in connectivity store 52. For example, connectivity agent 118 can store the result (connect/disconnect) and a corresponding timestamp for each probe (step 406). Steps 402-406 can be performed periodically over time.

At step 408, connectivity sense logic in cloud-managed on-premises software reads cloud-connectivity status from connectivity store. For example, at step 410, connectivity service 302 in VM management appliance 230 reads a latest probe result from connectivity store 52 (i.e., a probe result having a timestamp closest to the current time). In general, the cloud-managed on-premises software includes a service or logic for accessing connectivity store 52 to determine cloud connectivity. The on-premises software can read the current cloud connectivity status in response to various actions, such as a request from a user to access a user interface.

At step 412, connectivity logic in the cloud-managed on-premises software determines if SDDC 41 is connected to cloud platform 12. If so, method 400 proceeds to step 414, where the cloud-managed on-premises software executes with its licensed functionality. For example, at step 416, a user access VM management appliance 230 through UI 304 to access the full licensed functionality If at step 412 connectivity logic determines SDDC 41 is disconnected from cloud platform 12, method 400 proceeds to step 418. At step 418, the cloud-managed on-premises software executes with reduced functionality (which includes no functionality). For example, at step 420, VM management appliance 230 presents access request UI 306 to the user, which can prevent access or otherwise present reduced functionality (i.e., less than the licensed functionality).

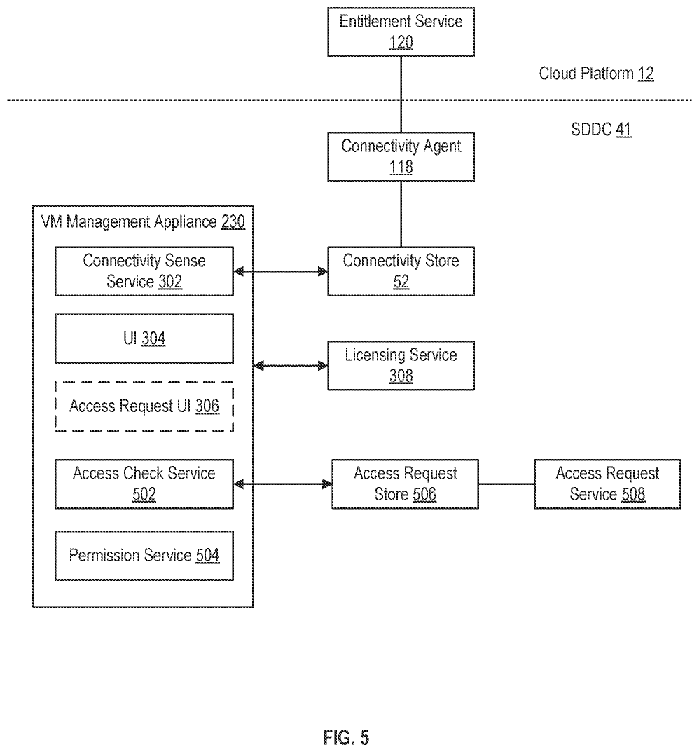

FIG. 5 is a block diagram depicting cloud connectivity management in a multi-cloud computing system according to further embodiments. Elements of FIG. 5 that are the same or similar to those of FIG. 3 are designated with identical reference numerals. In the embodiment, VM management appliance 230 further includes access check service 502 and permission service 504. SDDC 41 further includes an access request store 506 and an access request service 508 Access request service 508 can execute in a VM 236. In embodiments, access request store 506 can be a database executing in SDDC 41. In another embodiment, access request store 506 can include a file or files stored on storage (e.g., shared storage 270). In another embodiment, access request store 506 can include a portion of system memory (e.g., RAM 262) on a host 240 In any embodiment, access request store 506 stores policy check results generated by access request service 508. A policy check result includes an indication that a user's temporary access to cloud-managed on-premises software (e.g., VM management appliance 230) while there is a disconnection between SDDC 41 and cloud platform 12 complies with policy.

Access check service 502 can read a policy check result from access request store 506. For example, access request UI 306 can direct the user to access request service 508. Access request service 508 can determine the user's request for temporary access satisfies a policy and store the result in access request store 506. The policy can be defined by an administrator and includes requirements to be satisfied for temporary access. The policy, for example, can require the user to be valid, require that the user has not previously requested temporary access within a threshold time period, limit the number of concurrent temporary access requests across all users, and the like. The user can then again attempt accessing VM management appliance 230 through UI 304. UI 304 then invokes access check service 502 checks access request store 506 for a corresponding policy check result. If present and satisfied, access check service 502 invokes permission service 504. If not present or not satisfied, access check service 502 prevents the user access Permission service 504 determines if the user has permission to access VM management appliance 230 using temporary access authorization (e.g., granted by an administrator to the user or a group to which the user belongs). If so, the user can access VM management appliance 230 (e.g., with reduced functionality or licensed functionality as determined by VM management appliance 230). If the user does not have permission, permission service 504 denies the user temporary access Thus, access request service 508 and access check service 502 function to provide two checks before a user is allowed temporary access, namely, a policy check and a permission check. The user is granted temporary access upon passing both the policy check and the permission check. The user is denied temporary access upon failing either the policy check or the permission check. Access request service 506 and access request store 506 can be used by multiple cloud-managed on-premises services for performing policy checks for policy that is defined generally across all on-premises services. Access check service 502 and permission service 504 determine if a user has specific permission to access the specific on-premises software.

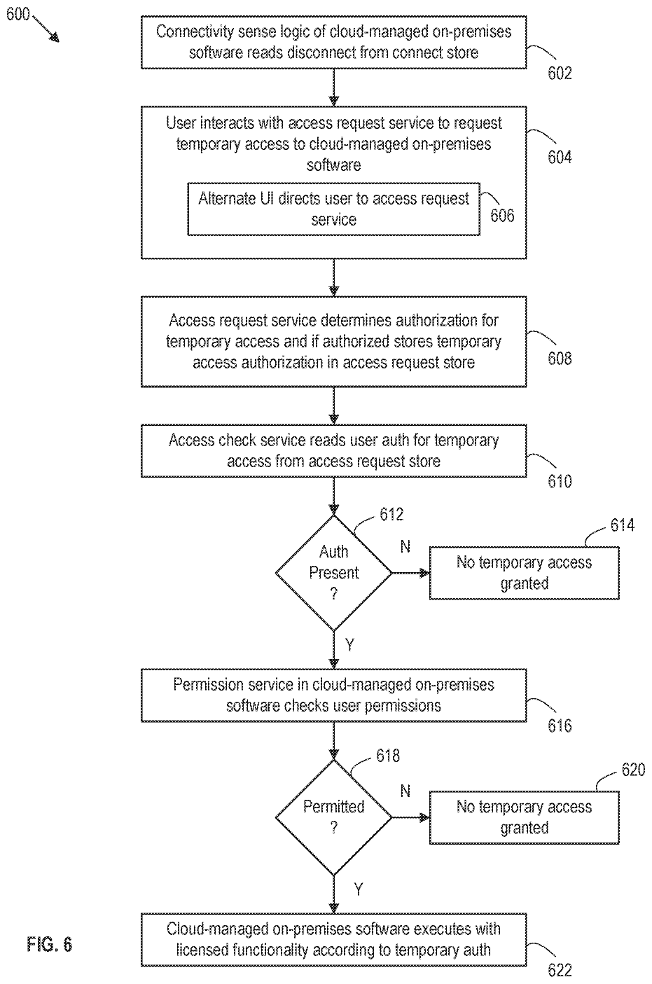

FIG. 6 is a flow diagram depicting a method 600 of managing temporary access to cloud-managed on-premises software in case of lost cloud connectivity according to embodiments Method 600 begins at step 602, where connectivity sense logic of the cloud-managed on-premises software reads a disconnect between SDDC 41 and cloud platform 12 from connect store 52. At step 604, a user interacts with access request service 508 to request temporary access to the cloud-managed on-premises software. For example, at step 606, access request UI 306 of VM management appliance 230 (or UI 304) can direct the user to access request service 508 in order to request temporary access. At step 608, access request service 508 determines authorization for temporary access and if authorized stores temporary access authorization in access request store 506 for the user If access request service 508 determines the user is not authorized for temporary access, no temporary access authorization is stored in access request store 506 for the user.

At step 610, access check service 502 reads the user authorization for temporary access from access request store 506 (if present). If not present, method 600 proceeds from step 612 to step 614, where the user is denied temporary access to the on-premises software. If authorization is present in access request store 506, method 600 proceeds from step 612 to step 616. At step 616, permission service 504 checks if the user has permission to access the on-premises software using temporary authorization. If not, method 600 proceeds from step 618 to step 620, where the user is denied temporary access to the on-premises software. Otherwise, method 600 proceeds from step 618 top step 622. At step 622, the cloud-managed on-premises software executes with licensed functionality (or functionality dictated by the temporary access) according to the temporary authorization.

One or more embodiments of the invention also relate to a device or an apparatus for performing these operations. The apparatus may be specially constructed for required purposes, or the apparatus may be a general-purpose computer selectively activated or configured by a computer program stored in the computer. Various general-purpose machines may be used with computer programs written in accordance with the teachings herein, or it may be more convenient to construct a more specialized apparatus to perform the required operations.

The embodiments described herein may be practiced with other computer system configurations including hand-held devices, microprocessor systems, microprocessor-based or programmable consumer electronics, minicomputers, mainframe computers, etc.

One or more embodiments of the present invention may be implemented as one or more computer programs or as one or more computer program modules embodied in computer readable media. The term computer readable medium refers to any data storage device that can store data which can thereafter be input to a computer system. Computer readable media may be based on any existing or subsequently developed technology that embodies computer programs in a manner that enables a computer to read the programs. Examples of computer readable media are hard drives, NAS systems, read-only memory (ROM), RAM, compact disks (CDs), digital versatile disks (DVDs), magnetic tapes, and other optical and non-optical data storage devices. A computer readable medium can also be distributed over a network-coupled computer system so that the computer readable code is stored and executed in a distributed fashion.

Although one or more embodiments of the present invention have been described in some detail for clarity of understanding, certain changes may be made within the scope of the claims. Accordingly, the described embodiments are to be considered as illustrative and not restrictive, and the scope of the claims is not to be limited to details given herein but may be modified within the scope and equivalents of the claims. In the claims, elements and/or steps do not imply any particular order of operation unless explicitly stated in the claims.

Virtualization systems in accordance with the various embodiments may be implemented as hosted embodiments, non-hosted embodiments, or as embodiments that blur distinctions between the two. Furthermore, various virtualization operations may be wholly or partially implemented in hardware. For example, a hardware implementation may employ a look-up table for modification of storage access requests to secure non-disk data.

Many variations, additions, and improvements are possible, regardless of the degree of virtualization. The virtualization software can therefore include components of a host, console, or guest OS that perform virtualization functions.

Plural instances may be provided for components, operations, or structures described herein as a single instance. Boundaries between components, operations, and data stores are somewhat arbitrary, and particular operations are illustrated in the context of specific illustrative configurations. Other allocations of functionality are envisioned and may fall within the scope of the invention. In general, structures and functionalities presented as separate components in exemplary configurations may be implemented as a combined structure or component. Similarly, structures and functionalities presented as a single component may be implemented as separate components. These and other variations, additions, and improvements may fall within the scope of the appended claims.

What is claimed is:

1. A method of managing on-premises software executing in a data center, the method comprising:
probing, by a connectivity agent executing in the data center, connectivity between a cloud service executing in a public cloud and the data center
storing, by the connectivity agent, probe results in a connectivity store of the data center;
reading, by connectivity sensing logic in the on-premises software, a current probe result from the connectivity store; and
providing, by the on-premises software to a user, functionality based on the current probe result.

2. The method of claim 1, wherein the on-premises software provides reduced functionality that is less than a licensed functionality in response to the current probe result indicating a disconnection between the cloud service and the data center.

3. The method of claim 2, wherein the reduced functionality includes denying access to the on-premises software by the user.

4. The method of claim 1, further comprising:
receiving, at an access request service executing in the data center, a request for temporary access to the on-premises software in response to the current probe indicating a disconnection between the cloud service and the data center; and
storing, by the access request service, an authorization result in an access request store of the data center.

5. The method of claim 4, further comprising:
reading, by access check logic in the on-premises software, the authorization result from the access request store;
wherein the on-premises software provides the functionality based on the current probe result and the authorization result.

6. The method of claim 5, wherein the on-premises software provides a licensed functionality on a temporary basis based on the authorization result.

7. The method of claim 5, wherein the on-premises software provides a licensed functionality on a temporary basis based on the authorization result and on having permission as determined by permission logic of the on-premises software.

8. A non-transitory computer readable medium comprising instructions to be executed in a computing device to cause the computing device to carry out a method of managing on-premises software executing in a data center, the method comprising:
probing, by a connectivity agent executing in the data center, connectivity between a cloud service executing in a public cloud and the data center;
storing, by the connectivity agent, probe results in a connectivity store of the data center;
reading, by connectivity sensing logic in the on-premises software, a current probe result from the connectivity store; and
providing, by the on-premises software to a user, functionality based on the current probe result.

9. The non-transitory computer readable medium of claim 8, wherein the on-premises software provides reduced functionality that is less than a licensed functionality in response to the current probe result indicating a disconnection between the cloud service and the data center.

10. The non-transitory computer readable medium of claim 9, wherein the reduced functionality includes denying access to the on-premises software by the user.

11. The non-transitory computer readable medium of claim 8, further comprising:
receiving, at an access request service executing in the data center, a request for temporary access to the on-premises software in response to the current probe indicating a disconnection between the cloud service and the data center; and
storing, by the access request service, an authorization result in an access request store of the data center.

12. The non-transitory computer readable medium of claim 11, further comprising:
reading, by access check logic in the on-premises software, the authorization result from the access request store;
wherein the on-premises software provides the functionality based on the current probe result and the authorization result.

13. The non-transitory computer readable medium of claim 12, wherein the on-premises software provides a licensed functionality on a temporary basis based on the authorization result.

14. The non-transitory computer readable medium of claim 12, wherein the on-premises software provides a licensed functionality on a temporary basis based on the authorization result and on having permission as determined by permission logic of the on-premises software.

15. A virtualized computing system, comprising:
a public cloud in communication with a data center through a messaging fabric;
a cloud service executing in the public cloud configured to manage on-premises software executing in the data center;
a connectivity agent executing in the data center configured to probe connectivity between the cloud service and the data center and store the probe results in a connectivity store of the data center; and
connectivity sensing logic in the on-premises software configure to read a current probe result from the connectivity store;
wherein the on-premises software is configured to provide functionality based on the current probe result.

16. The virtualized computing system of claim 15, wherein the on-premises software provides reduced functionality that is less than a licensed functionality in response to the current probe result indicating a disconnection between the cloud service and the data center.

17. The virtualized computing system of claim 16, wherein the reduced functionality includes denying access to the on-premises software.

18. The virtualized computing system of claim 15, further comprising:
an access request service executing in the data center configured to receive a request for temporary access to the on-premises software in response to the current probe indicating a disconnection between the cloud service and the data center; and
an access request store in the data center configured to store an authorization result generated by the access request service.

19. The virtualized computing system of claim 18, further comprising:
access check logic in the on-premises software configured to read the authorization result from the access request store;
wherein the on-premises software provides the functionality based on the current probe result and the authorization result.

20. The virtualized computing system of claim 18, wherein the on-premises software provides a licensed functionality on a temporary basis based on the authorization result and on having permission as determined by permission logic of the on-premises software.
